(19) United States
(12) Patent Application Publication
(10) Pub. No.: US 2007/0176776 A1
(43) Pub. Date: Aug. 2, 2007

(54) Wireless sensor system

(75) Inventors: Kazuhiro Kashiwagi, Tokyo (JP); Hiroyuki Koide, Tokyo (JP); Yoshiharu Kawai, Tokyo (JP); Yasushi Kikukawa, Tokyo (JP)

Correspondence Address: DUANE MORRIS, LLP;IP DEPARTMENT, 30 SOUTH 17TH STREET, PHILADELPHIA, PA, 19103-4196, US

(73) Assignee: KOWA COMPANY, LTD.

(21) Appl. No.: 11/522,301

(22) Filed: Sep. 15, 2006

(30) Foreign Application Priority Data
Jan. 30, 2006 (JP) 2006-021510

(51) Int. Cl. G08B 13/08; G08B 1/08

(52) U.S. Cl. 340/545.1; 340/539.1

(57) ABSTRACT

A wireless sensor system according to the invention has a wireless sensor device for detecting opening and closing of a door or a window, and a wireless base station for exchanging data with the wireless sensor device 2 by wireless. A detected direction setting portion for setting a direction where an acceleration is detected and a sensitivity level setting portion for setting a sensitivity level of the wireless sensor device are located on the wireless base station side so as to set the detected direction and the sensitivity level on the wireless base station side. Then, it is not necessary to set both on the wireless sensor device, and the setting is simple, thereby.

### BACKGROUND OF THE INVENTION

The invention relates to a wireless sensor system for exchanging data between a wireless sensor device and a wireless base station by wireless.

A wireless sensor system for detecting presence of invaders with a wireless sensor has been proposed (see Japanese patent application publication number of which is H10-326384 (“the document 1” hereinafter).

FIG. 8 is a typical view showing one example of a structure of a conventional wireless sensor system. A reference numeral 120 of FIG. 8 denotes a sensor which is located at each place, a reference numeral 121 denotes a transmitter for transmitting information detected by the sensor 120 with a wireless signal, and a reference numeral 103 denotes a controller for centralized control.

Besides, an art for detecting whether a subject to be watched moves or not with an acceleration sensor has been proposed (see Japanese patent application publication number of which is 2003-151038 (“the document 2” hereinafter)).

Then, it is possible to produce the wireless sensor system as shown in the document 1 by locating the acceleration sensor as shown in the document 2 at a door portion of a window portion which is opened or closed.

A door or a window may move horizontally or up and down, rotate around a vertical axis, or rotate around a horizontal axis. And, a direction where an acceleration is changed is different, depending on the type of a door or a window (according to how to move). How to move the door or the window is various, relatively rapid movement or slow movement. That is, it is necessary to set the direction where an acceleration is detected and a sensor sensitivity, separately for each acceleration sensor. If both are necessary to be set on both the sensor 120 and the controller 103 sides, a worker is necessary to go and return between the sensor 120 and the controller 103, so that the work for its adjustment is troublesome.

On the other hand, the sensor output may change due to various reasons after attaching the acceleration sensor. If the acceleration sensor is fixed only with a double-faced tape or the like, the acceleration sensor may be inclined from a normal attachment position, and due to this inclination, the sensor output may be changed. Besides, the sensor output may be also changed due to a change of temperature or a change of voltage, such as a change of voltage of a battery. In the worst case, it is impossible to detect opening and closing.

An object of the invention is to provide a wireless sensor system for solving the above-mentioned problems.

### SUMMARY OF THE INVENTION

One aspect of the invention is wireless sensor system having a wireless sensor device and a wireless base station, for exchanging data by wireless, comprising:

said wireless sensor device having an acceleration sensor for detecting whether a movable body, such as a door and a window, is moved or not, a sensor-side transmitting and receiving portion for exchanging data with said wireless base station, and a CPU; and

said wireless base station having a base station-side transmitting and receiving portion for exchanging said data with said wireless sensor device, a detected direction setting portion for setting a direction where an acceleration is detected, and a sensitivity level setting portion for setting a sensitivity level of said acceleration sensor.

The other aspect of the invention is the wireless sensor system, wherein said wireless sensor device has a threshold value output portion for outputting a threshold value which is a basis for judging whether said movable body is moved or not, and a movement judging portion for judging whether said movable body is moved or not by comparing said threshold value outputted from said threshold value output portion and an output from said acceleration sensor with each other.

According to both aspects of the invention, it is possible to set the direction where the acceleration is detected and the sensitivity level only on the wireless base station side, and is not necessary to go and return between the wireless base station and the wireless sensor device, and the setting work can be made simple thereby.

Another aspect of the invention is the wireless sensor system wherein said wireless sensor device has an average computing portion for computing an average of an output from said acceleration sensor, and a threshold value computing portion for computing a threshold value on the basis of a value computed by said average computing portion, and said threshold value computed by said threshold value computing portion is inputted into said threshold value output portion.

According to this aspect of the invention, the movement of the movable body can be correctly judged even if the output of the acceleration sensor is changed due to an influence of temperature since the threshold value which is a basis for judging whether or not the movable body is moved is renewed on the basis of the output from the acceleration sensor.

### BRIEF DESCRIPTION OF THE DRAWINGS

FIG. 1 is a schematic view showing one example of the whole formation of a wireless sensor system according to the invention;

FIG. 2 is a block diagram indicating one example of a formation of a wireless sensor device;

FIG. 3 is a block diagram indicating one example of a formation of a wireless base station;

FIG. 4 is a typical view showing one example of a screen which is displayed on a monitor of a personal computer;

FIG. 5 is a typical view for explaining a method of setting a direction where an acceleration is detected;

FIG. 6 is a view showing a wave form of an analog output of an acceleration sensor;

FIG. 7 is a characteristic view showing a characteristic of temperature dependency of an acceleration sensor output; and

FIG. 8 is a typical view showing one example of a structure of a conventional wireless sensor system.

### DESCRIPTION OF THE PREFERRED EMBODIMENTS

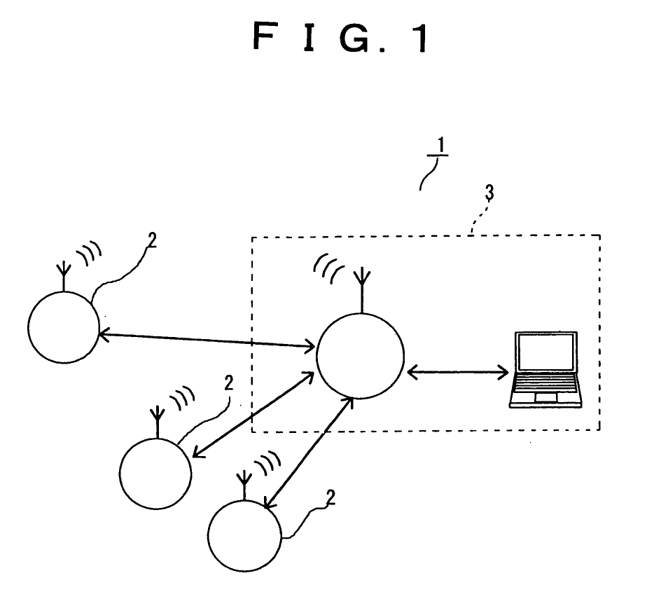

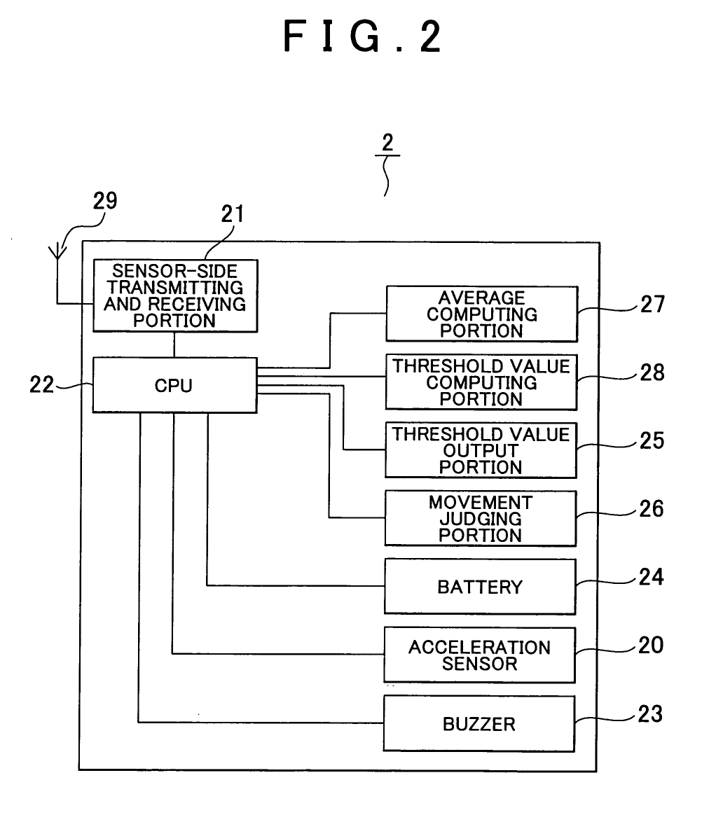

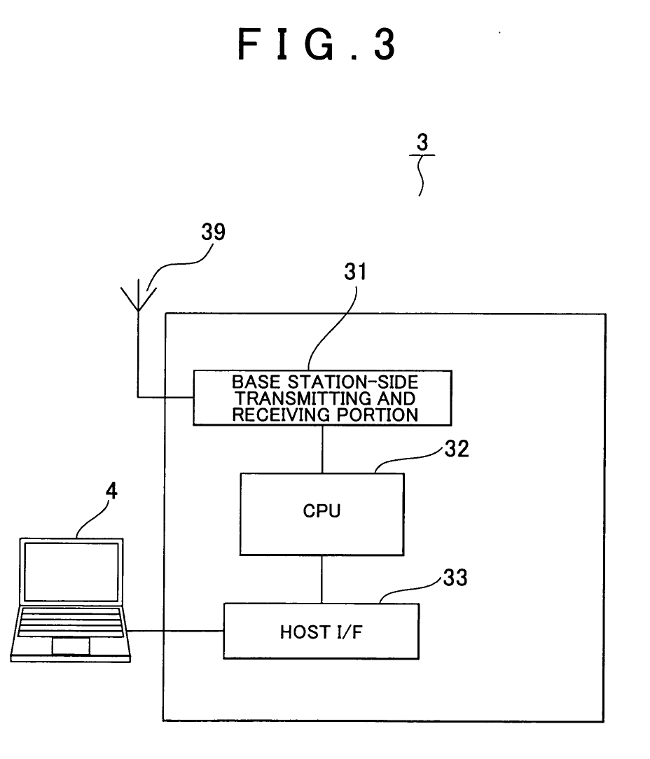

The best mode of an embodiment for executing the invention will now be explained, referring to FIGS. 1 trough 3, hereinafter. FIG. 1 is a schematic view showing one example of the whole formation of a wireless sensor system according to the invention, FIG. 2 is a block diagram indicating one example of a formation of a wireless sensor device, and FIG. 3 is a block diagram indicating one example of a formation of a wireless base station.

A wireless sensor system according to the invention exemplarily illustrated with a reference numeral 1 in FIG. 1 has a wireless sensor device 2 and a wireless base station 3 in order to exchange data by wireless.

As shown in FIG. 2, the wireless sensor device 2 is provided with an acceleration sensor 20 for detecting whether a movable body (not shown) such as a door and a window, is moved or not, a sensor-side transmitting and receiving portion 21 for exchanging data with the wireless base station 3, and a CPU 22. And, a power supply (battery) may be built into the above-mentioned wireless sensor device 2.

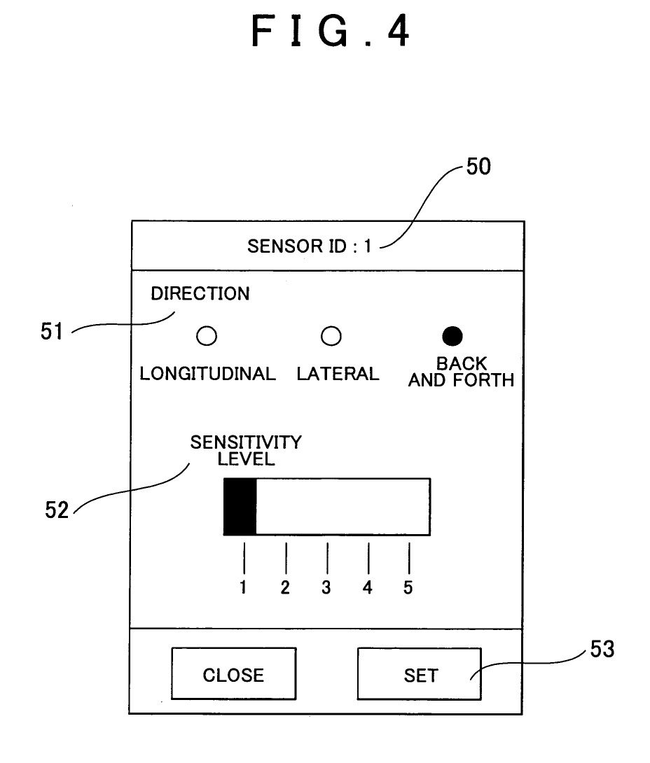

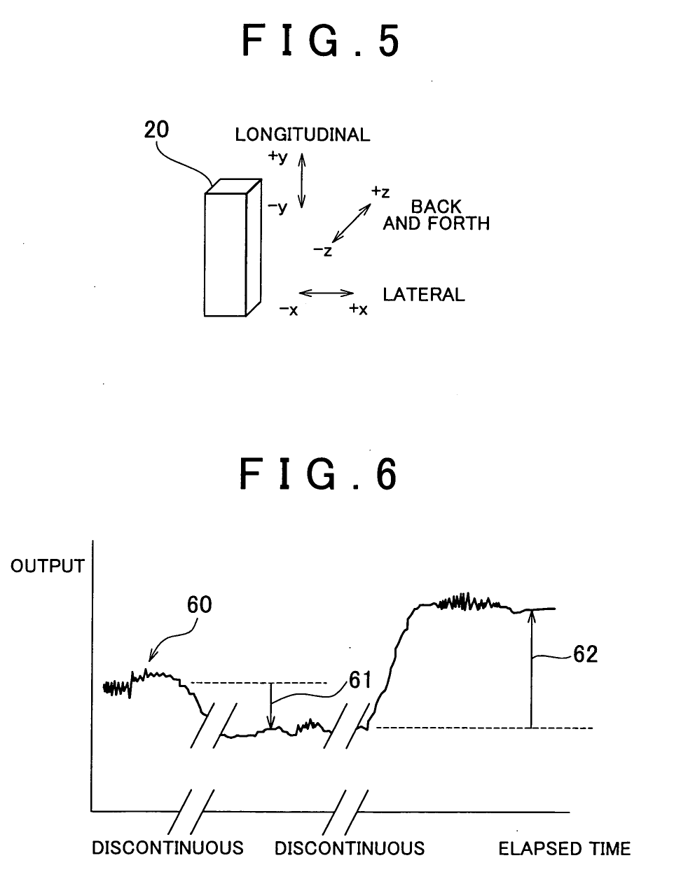

As shown in FIG. 3, the wireless base station 3 is provided with a base station-side transmitting and receiving portion 31 for exchanging data with the wireless sensor device 2, a detected direction setting portion (see a reference numeral 51 of FIG. 4) for setting a direction where an acceleration is detected, and a sensitivity level setting portion (see a reference numeral 52 of FIG. 4) for setting a sensitivity level of the acceleration sensor 20. Information for setting in both setting portions 51, 52 is sent from the base station-side transmitting and receiving portion 31 to the wireless sensor device 2, and it is possible to set a detected direction of the acceleration sensor 20 and the sensitivity level thereof. The direction where an acceleration is detected corresponds with a direction where the movable body is moved, and is determined by the direction concerning the acceleration sensor 20 (e.g. “a lateral direction ±x”, “a longitudinal direction ±y”, or “a back and forth direction ±z” in FIG. 5). That is, in the detected direction setting portion 51, if the direction where the movable body is moved is “the lateral direction ±x”, “lateral” is selected, if the direction where the movable body is moved is “the longitudinal direction ±y”, “longitudinal” is selected, and if the direction where the movable body is moved is “the back and forth direction ±z”, “back and forth” is selected. And, an arbitrary level may be selected from two or more levels (e.g. third to tenth grade or so) as the sensitivity level. According to the present invention, a setting work can be easily done because the direction where an acceleration is detected and the sensitivity level can be set only on the wireless base station 3 side and it is not necessary to go and return between the wireless base station 3 and the wireless sensor device 2.

In the above-mentioned case, preferably, the wireless sensor device 2 has a threshold value output portion 25 for outputting a threshold value which is a basis for judging whether the movable body is moved or not, and a movement judging portion 26 for judging whether the movable body is moved or not by comparing the threshold value outputted from the threshold value output portion 25 and an output from the acceleration sensor 20 with each other.

Preferably, the wireless sensor device 2 is provided with an average computing portion 27 for computing an average of output from the acceleration sensor 20, and a threshold value computing portion 28 for computing a threshold value on the basis of a value computed by the average computing portion 27 so as to input the threshold value computed by the threshold value computing portion 28 into the threshold value output portion 25. With such a structure, the threshold value which is a standard for judging whether or not the movable body is moved is renewed, basing on output from the acceleration sensor 20, so that the movement of the movable body can be accurately judged even if the output from the acceleration sensor 20 receives an influence from a temperature or so and changes.

### Embodiment 1

There constructed a wireless sensor system indicating in FIG. 1 through FIG. 3 in this embodiment. Following is a concrete explanation.

As shown in FIG. 1, the wireless sensor system 1 according to the present invention has two or more wireless sensor devices 2, and the sensor base station 3 (the wireless base station) for exchanging data with each wireless sensor device 2 by wireless.

As shown in FIG. 2, each wireless sensor device 2 has the acceleration sensor 20 for detecting whether a door or a window is opened or closed, the CPU 22, the sensor-side transmitting and receiving portion 21 for exchanging data with the sensor base station 3, an antenna 29, a buzzer 23, and a battery 24. The CPU 22 is a one-chip microcomputer, and a ROM, a RAM, a flash memory and an A/D conversion circuit, and a digital I/O circuit are installed in the CPU 22. Control program is built into a ROM or a flash memory in order to control the sensor-side transmitting and receiving 21 and to obtain and process the data of the acceleration sensor 20. Values measured by the sensor are stored in the RAM. And, an analog signal from the acceleration sensor 20 is converted into a digital signal by the A/D conversion circuit built in the CPU 22, and the converted digital signal is stored in the RAM 22 for post-processing. Data is transmitted to the sensor base station 3 only when an output value of the acceleration sensor 20 exceeds a designated value without transmitting all the time, and power to be consumed can be decreased thereby. And, the data received from the sensor base station 3 may be used for the setting change and designation operation.

As indicated in FIG. 3, the sensor base station 3 is provided with the base station-side transmitting and receiving portion 31 for exchanging data with each sensor device 2, an antenna 39, a CPU 32, and a host I/F 33 which is connected with a personal computer 4. Control software is built into the CPU 32 in order to control the base station-side transmitting and receiving portion 31 and the host I/F 33.

And, control software is installed in the personal computer 4 so that a screen as shown in FIG. 4 can be displayed on the monitor. On the screen as shown in FIG. 4, it is possible to select the acceleration sensor with an ID (see the reference numeral 50), the direction where the acceleration is detected (see the reference numeral 51) from “longitudinal”, “lateral”, and “back and forth”, and the sensitivity level (1 is sensitive and 5 is insensitive) (see the reference numeral 52). So, when clicking a set button 53, setting information is sent to the selected sensor device 2 and the setting finishes. That is, in this embodiment, an installation of the control software in the personal computer 4 provides a detected direction setting portion for setting the direction where acceleration is detected and a sensitivity level setting portion for setting the sensitivity level of the acceleration sensor 20. The directions “longitudinal”, “lateral”, and “back and forth” are set on side of the wireless sensor device 2 as indicated in FIG. 5, so that it is sufficient to set the direction which corresponds with one where a door or a window is opened or closed as the detected direction. And, the control software to be executed in a personal computer is set and operated by means of a touch panel, a mouse, and a keyboard of the personal computer, or is set and operated with the other personal computer using the www server function thereof. When thinking a relation between a standard direction of the sensor and a direction where the sensor is actually attached, the direction where the sensor is actually attached is determined from a constant output value of the sensor since a direction where a gravitational acceleration is added is known from this value. And, the screen for setting can display a view adding the actual attachment direction thereon, also.

The above-mentioned wireless sensor device 2 is provided with the threshold value output portion 25 for outputting a threshold value which is a basis when judging opening and closing of a door or the like, and the movement judging portion 26 for judging whether a door or the like is opened or closed by comparing the result detected by the acceleration sensor 20 and the threshold value outputted from the threshold value output portion 25 with each other.

And, the wireless sensor device 2 is provided with the average computing portion 27 for computing an average of the sensor output, and the threshold value computing portion 28 for computing the threshold value on the basis of the computed average in order to input the threshold value computed by the threshold value computing portion 28 into the threshold value output portion 25 in order.

Following is an explanation for an update of the threshold value.

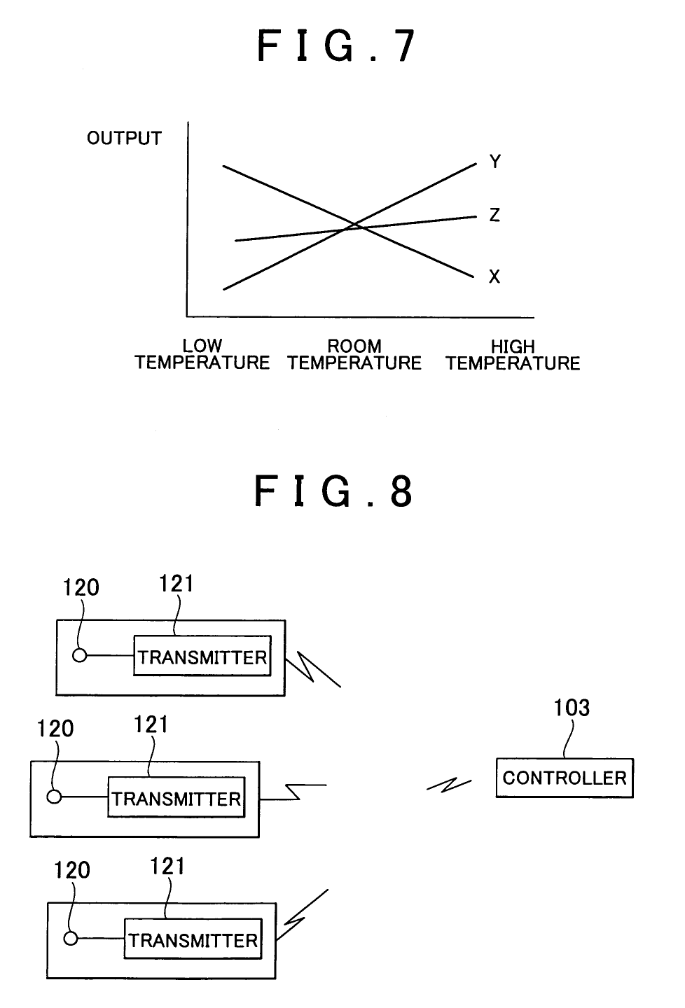

Even if a door or the like is stationary without being opened and closed, an analog output of the acceleration sensor 20 may be changed without taking a constant value as indicated in FIG. 6 for example. A high frequency noise as shown in a reference numeral 60 in the figure which is one from a power circuit is changed along with a fluctuation of an output voltage of a battery in its size. The analog output of the acceleration sensor 20 also changes when an ambient temperature changes and the position where the sensor is attached shifts (see reference numerals 61, 62). In case of a three-axis acceleration sensor, as indicated in FIG. 7, a tendency of the change of the sensor output is different, depending on the axis. And, the position where the sensor is attached may be shifted when the sensor is bonded with a double-faced tape or the like.

Then, in this embodiment, the analog data from the acceleration sensor 20 is converted into ten (10) bits of digital data (that is, data 0 through 1023) with the A/D conversion circuit in the CPU 22 so that ten (10) data can be obtained every 64 mS. And, an average D and an amplitude of eight data among these ten (10) data of d[0], d[1], . . . d[9] except the maximum and the minimum thereof are obtained and the obtained is stored in the memory (not shown) in the CPU. The memory can store fifty averages D and fifty amplitudes a. When obtaining the fifty-first data, the oldest data of the fifty data is replaced by the fifty-first data and the replaced is stored. The average computing portion 27 computes an average Ad of D and an average Aa of the amplitude a on the basis of the fifty data. Moreover, the threshold value computing portion 28 obtains a threshold value S on the basis of the values Ad and Aa. K in an expression is a sensitivity factor which is set for each sensitivity level in advance (see an chart below). Dmax is a value which is determined by number of bits of the A/D conversion circuit, for example, the value is 1024 for ten bits.

### <Expression 1>

S=Ad±(Aa/2)±(Dmax/2)*K

CHART 1

| Sensitivity level x | Sensitivity factor K |
|---|---|
| 1 | 0.01 |
| 2 | 0.02 |
| 3 | 0.05 |
| 4 | 0.1 |
| 5 | 0.2 |

The thus obtained threshold value S is inputted in the threshold value output portion 25, and opening of a door or a window is judged when

Sensor output>Ad+(Aa/2)+(Dmax/2)*K=S₁

(Preferably, the threshold value S₁ is the maximum “Dmax-1” since the maximum value of the sensor output is “Dmax-1 (1023 when number of bits of the A/D conversion circuit is 10)”

or

Sensor output<Ad−(Aa/2)−(Dmax/2)*K=S₂

(Preferably, the threshold value S₂ is the minimum “zero” since the minimum value of the sensor output is “zero”.).

The present invention is explained on the basis of the embodiment heretofore. The embodiments which are described in the present specification are illustrative and not limiting. The scope of the invention is designated by the accompanying claims and is not restricted by the descriptions of the specific embodiments. Accordingly, all the transformations and changes belonging to the claims are included in the scope of the present invention.

1. Wireless sensor system having a wireless sensor device and a wireless base station, for exchanging data by wireless, comprising:
said wireless sensor device having an acceleration sensor for detecting whether a movable body, such as a door and a window, is moved or not, a sensor-side transmitting and receiving portion for exchanging data with said wireless base station, and a CPU; and
said wireless base station having a base station-side transmitting and receiving portion for exchanging said data with said wireless sensor device, a detected direction setting portion for setting a direction where an acceleration is detected, and a sensitivity level setting portion for setting a sensitivity level of said acceleration sensor.

2. The wireless sensor system according to claim 1, wherein said wireless sensor device has a threshold value output portion for outputting a threshold value which is a basis for judging whether said movable body is moved or not, and a movement judging portion for judging whether said movable body is moved or not by comparing said threshold value outputted from said threshold value output portion and an output from said acceleration sensor with each other.

3. The wireless sensor system according to claim 2 wherein said wireless sensor device has an average computing portion for computing an average of an output from said acceleration sensor, and a threshold value computing portion for computing a threshold value on the basis of a value computed by said average computing portion, and said threshold value computed by said threshold value computing portion is inputted into said threshold value output portion.
